(19) United States
(12) Patent Application Publication
(10) Pub. No.: US 2014/0346024 A1
(43) Pub. Date: Nov. 27, 2014

(54) OPERATING KEY AND OPERATING DEVICE

(71) Applicant: Funai Electric Co., Ltd., Osaka (JP)

(72) Inventor: Seiji YAMAUCHI, Daito-shi (JP)

(73) Assignee: Funai Electric Co., Ltd., Osaka (JP)

(21) Appl. No.: 14/283,297

(22) Filed: May 21, 2014

(30) Foreign Application Priority Data
May 27, 2013 (JP) 2013-111305

(51) Int. Cl. H01H 9/18; H01H 13/83

(52) U.S. Cl. CPC H01H 9/18; H01H 13/83; H01H 2219/00
USPC 200/5 A; 200/308

(57) ABSTRACT

An operating key includes a recessed portion on a top surface thereof, and the recessed portion includes a bottom surface and wall surfaces. A graphic is configured with paint on the bottom surface, and the graphic is circumscribed by at least a portion of the wall surfaces.

### BACKGROUND OF THE INVENTION

1. Field of the Invention

The present invention relates to an operating key and an operating device including the operating key.

2. Description of the Related Art

Remote control devices have conventionally been provided with a plurality of operating keys on the top surfaces of which characters are provided (for example, see Japanese Patent Application Laid-Open Publication No. 2013-50266).

For instance, characters are provided on the top surfaces of the operating keys to indicate the functions assigned to the operating keys. When the user operates an operating key, a signal that indicates the function assigned to the operating key is output to the main device, and the main device performs processing based on this signal.

An operating key is operated by the user pressing downward on the top surface of this operating key, so the graphics provided on the top surfaces of the operating keys are prone to being chipped or peeled off if the user repeatedly operates the operating keys. Once the graphics on the top surfaces of the operating keys are chipped or peeled off in this manner, the user will find it difficult to ascertain by looking at the operating keys which functions are assigned to these keys.

### SUMMARY OF THE INVENTION

Preferred embodiments of the present invention provide an operating key that reduces chipping and peeling of graphics on a top surface of the operating key even when the top surface of the operating key is pressed repeatedly, as well as an operating device including such an operating key.

An operating key according to a preferred embodiment of the present invention is an operating key including a recessed portion providing in a top surface of the operating key, the recessed portion includes a bottom surface and wall surfaces, a graphic is configured with paint on the bottom surface, and the graphic is circumscribed by at least a portion of the wall surfaces.

A recessed portion is preferably provided on the top surface of the operating key, a graphic is configured with paint on the bottom surface of the recessed portion, and the graphic is circumscribed by at least a portion of the wall surfaces of the recessed portion.

With this configuration, when the user presses the top surface of an operating key, it is difficult for a finger to reach the lower portions of the wall surfaces of the recessed portion, and even if the finger reaches the lower portions, the area of the contact surface between the graphic and the fingertip is reduced, so it is possible to significantly reduce or prevent chipping and peeling of the graphic on the bottom surface of the recessed portion.

The bottom surface may preferably have a quadrangular or substantially quadrangular shape, for example.

With this configuration, the bottom surface of the recessed portion preferably has a quadrangular or substantially quadrangular shape, which therefore facilitates circumscribing the graphic with the wall surfaces of the recessed portion.

Furthermore, the graphic may represent text so that the user ascertains what sort of function is assigned to the operating key.

Moreover, a groove that corresponds to the shape of the graphic may be provided in the bottom surface, and the paint may be made to flow into the groove.

The groove that corresponds to the shape of the graphic is preferably provided in the bottom surface, and paint is made to flow into the groove. Therefore, even if the paint surface chips or peels, because paint has flowed into the interior of the groove, it is possible to reduce the susceptibility to such effects on the legibility of the graphic on the top surface of the operating key.

The groove may be configured such that the cross section thereof preferably has a triangular or substantially triangular shape with a vertex facing downward, for example.

With this configuration, the groove preferably has a cross section that is triangular or substantially triangular with a vertex facing downward, so it is difficult for the user's finger to reach the bottom of the groove. This therefore makes it possible to reduce chipping and peeling of paint at the bottom of the groove, so it is possible to have the legibility of the graphic on the top surface of the operating key be less susceptible to such effects.

Alternatively, the groove may be such that the cross section of the groove preferably has a reverse trapezoid shape, for example.

Because the groove preferably has a cross section that is a reverse trapezoid shape, it is difficult for the user's finger to reach the lower portion of the groove. Accordingly, it is possible to reduce chipping and peeling of paint accumulated at the bottom of the groove, so the legibility of the graphic on the top surface of the operating key is less prone to these effects.

Alternatively, the groove may be such that the cross section of this groove preferably has a quadrangular or quadrangular shape, for example.

With this configuration, because the cross section of the groove preferably has a quadrangular or substantially quadrangular shape, the mold that is used when forming the groove is created easily.

Alternatively, the groove may be such that the cross section of this groove preferably has a downward-facing curved shape, for example.

The groove preferably has a cross section that is a downward-facing curved shape, so it is difficult for the fingertip to reach the bottom portion of the groove. For this reason, it is possible to reduce chipping and peeling of paint accumulated at the bottom of the groove, so the legibility of the graphic on the top surface of the operating key is less susceptible to such effects.

In addition, the height of the wall surfaces from the bottom surface preferably may be equal or substantially equal to the height of the paint from the bottom surface.

With this configuration, the height of the wall surfaces from the bottom surface preferably is equal or substantially equal to the height of the paint from the bottom surface, so the depression that outlines the graphic becomes shallower. As a result, any odd sensation felt when pressing the top surface of the operating key is significantly reduced or prevented.

Furthermore, the operating key according to another preferred embodiment of the present invention is configured such that a top-layer member and a bottom-layer member that is different in color from the top-layer member are laminated, a hole is provided in the shape of a graphic in the top-layer member, and a recessed portion is provided in the bottom-layer member directly beneath the hole.

With this configuration, because the graphic preferably is provided with a hole in the top-layer member and the recessed portion that is directly beneath it, there is no chipping of the graphic due to friction or the like as there is with paint, meaning that the shape of the graphic is less prone to deterioration than when the graphic is configured using paint. Accordingly, the legibility of the graphic on the top surface of the operating key is less susceptible to such effects.

The recessed portion may be such that the cross section thereof preferably has a reverse trapezoid shape, for example.

With such a configuration, the recessed portion in the bottom-layer member preferably has a cross section with a reverse trapezoid shape, so it is difficult for the fingertip to reach the bottom of the recessed portion. Therefore, the shape of the recessed portion is less susceptible to deterioration, so the legibility of the graphic on the top surface of the operating key is less susceptible to these effects.

Alternatively, the recessed portion may be such that the cross section thereof has a reverse triangle shape, for example.

With this configuration, the recessed portion in the bottom-layer member preferably has a cross section with a reverse triangle shape, so it is difficult for the fingertip to reach the bottom of the recessed portion. Therefore, the shape of the recessed portion is less susceptible to deterioration in the same way as described above, so it is possible to have the legibility of the graphic on the top surface of the operating key be less affected by deterioration.

Alternatively, the recessed portion may be such that the cross section thereof preferably has a downward-facing curved shape.

With this configuration, the recessed portion in the bottom-layer member preferably has a cross section with a downward-facing curved shape, so it is difficult for the fingertip to reach the bottom of the recessed portion. Accordingly, the shape of the recessed portion is less susceptible to deterioration in the same way as described above, so it is possible to have the legibility of the graphic on the top surface of the operating key be less affected by deterioration.

Alternatively, the hole of the top-layer member may have a shape that preferably becomes narrower toward the bottom-layer member, for example.

With this configuration, the hole of the top-layer member has a shape that becomes narrower toward the bottom-layer member, so the bottom portion of the hole is less prone to chipping by the fingertip. Accordingly, the legibility of the graphic on the top surface of the operating key is less susceptible to these effects.

Furthermore, the hole may preferably have a tapered shape, for example.

Because the hole of the top-layer member preferably has a tapered shape, the graphic on the top surface of the operating key can be viewed not only from above but also at an angle from above, so the ease of use of the operating device equipped with this operating key is significantly increased.

Moreover, the operating device according to another preferred embodiment of the present invention is an operating device including a plurality of the operating keys according to one of the preferred embodiments of the present invention described above, and in which a function is assigned in advance to each of the operating keys, and when each of the operating keys is operated, a signal that indicates the function assigned to the operating key is output.

This configuration makes it possible to provide an operating device that exhibits the effects described above because it include the operating keys.

With various preferred embodiments of the present invention, chipping and peeling of graphics on the top surfaces of operating keys is significantly reduced or prevented even when the top surfaces of the operating keys are pressed repeatedly.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a front view showing one example of the external appearance of the operating device according to Preferred Embodiment 1 of the present invention.

FIG. 2 is a diagram showing a usage example of the operating device of FIG. 1.

FIG. 3A is a perspective view showing one example of the external appearance of a number key.

FIG. 3B is a sectional view along line A-A in FIG. 3A.

FIG. 4A is a sectional view showing one example of the configuration of the operating key according to Preferred Embodiment 2 of the present invention.

FIG. 4B is a sectional view showing one example of the configuration of the operating key according to Preferred Embodiment 2 of the present invention.

FIG. 4C is a sectional view showing one example of the configuration of the operating key according to Preferred Embodiment 2 of the present invention.

FIG. 4D is a sectional view showing one example of the configuration of the operating key according to Preferred Embodiment 2 of the present invention.

FIG. 5 is a sectional view showing one example of the configuration of the operating key according to Preferred Embodiment 3 of the present invention.

FIG. 6A is a perspective view showing one example of the external appearance of the operating key according to Preferred Embodiment 4 of the present invention.

FIG. 6B is a sectional view along line B-B in FIG. 6A.

FIG. 7 is a diagram for illustrating a method for manufacturing the number key 10J according to Preferred Embodiment 4 of the present invention.

FIG. 8A is a sectional view showing one example of the configuration of the operating key according to Preferred Embodiment 5 of the present invention.

FIG. 8B is a sectional view showing one example of the configuration of the operating key according to Preferred Embodiment 5 of the present invention.

FIG. 9 is a sectional view showing one example of the configuration of the operating key according to Preferred Embodiment 6 of the present invention.

FIG. 10 is a sectional view showing one example of the configuration of the operating key according to Preferred Embodiment 7 of the present invention.

FIG. 11 is a diagram for illustrating a method for manufacturing the number key according to Preferred Embodiment 7 of the present invention.

### DETAILED DESCRIPTION OF THE PREFERRED EMBODIMENTS

Preferred embodiments of the present invention will be described in detail below with reference to the drawings. Note that each of the preferred embodiments to be described below represents a comprehensive or specific example. The constituent elements, the disposed positions and connection modes of the constituent elements, and so forth indicated in the preferred embodiments below are merely non-limiting examples and do not limit the present invention.

### Preferred Embodiment 1

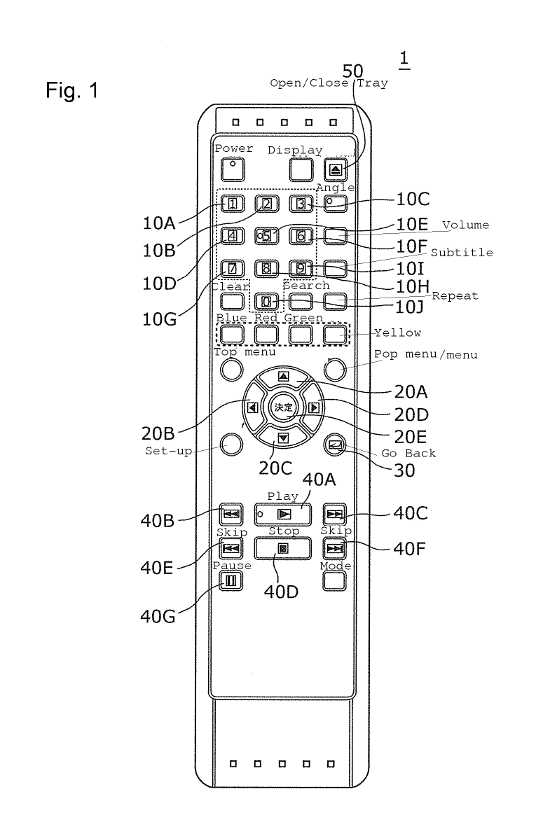

FIG. 1 is a front view showing one example of the external appearance of the operating device according to Preferred Embodiment 1 of the present invention. FIG. 2 is a diagram showing a usage example of the operating device of FIG. 1.

The operating device 1 preferably is a DVD remote control to remote operating a DVD player 2, for example. Note that in this description, a DVD remote control is shown as an example of the operating device 1, but the present invention is not limited to this example and is applied to controllers that remotely operate devices using radio or infrared rays, such as the remote control of a television 3.

The DVD player 2 is a device configured to play back DVDs housed within a tray 5, and it is connected to the television 3 by a cable 4.

The DVD player 2 obtains video and audio signals from the housed DVD and sends the video and audio signals to the television 3 through the cable 4. The television 3 receives the audio and video signals from the DVD player 2 and outputs video and audio based on these signals.

The DVD remote control 1 includes operating keys to which various functions are assigned. When an operating key is pressed, information indicating the function assigned to the operating key is output to the DVD player 2 in the form of a radio signal or infrared signal.

The operating keys provided on the operating device 1 will be described below. Note that the number key 10J according to this Preferred Embodiment 1 preferably has a rectangular or substantially rectangular parallelepiped shape that is longer in the lateral direction, but the shape is not limited to this. The key 10J may have any shape that allows a graphic to be provided on its top surface, such as a cube or a truncated quadrangular pyramid, for example.

Moreover, preferred embodiments of the present invention relate to graphic-bearing keys, which are operating keys on the top surfaces of which graphics are provided, and relate to operating devices that have such graphic-bearing keys, so the description will only involve graphic-bearing keys.

Accordingly, operating keys on the top surfaces of which no graphic is provided (in this Preferred Embodiment 1, the power key, display key, angle key, volume key, subtitle key, repeat key, search key, clear key, Blue key, Red key, Green key, Yellow key, top menu key, pop-up/menu key, set-up key, and mode key) will be merely depicted, and the description thereof will be omitted.

The operating device 1 is equipped with number keys 10A through 10J as its graphic-bearing keys, for example. A number is provided, as the graphic, on the top surface of each of these number keys 10A through 10J. When each of these number keys 10A through 10J is operated, information that indicates the number provided on the top surface of the operated number key is output to the DVD player 2.

The operating device 1 is also equipped with, as its graphic-bearing keys, an up cursor key 20A (which bears an up arrow as its graphic), a left cursor key 20B (which bears a left arrow as its graphic), a down cursor key 20C (which bears a down arrow as its graphic), and a right cursor key 20D (which bears a right arrow as its graphic).

When the respective cursor keys 20A through 20D are operated, information that indicates up, information that indicates left, information that indicates down, and information that indicates right are respectively output to the DVD player 2.

In addition, the operating device 1 is equipped with a select key 20E as a graphic-bearing key. The text “Select” is provided on the select key 20E as its graphic. When the select key 20E is operated, information that indicates “select” is sent to the DVD player 2.

Furthermore, the operating device 1 is equipped with a go-back key 30 as a graphic-bearing key. The text “Go Back” is provided on the go-back key 30 as its graphic. When the go-back key 30 is operated, information that indicates “go-back” is sent to the DVD player 2.

Moreover, the operating device 1 is equipped with a play key 40A, a rewind key 40B, a fast-forward key 40C, a stop key 40D, a rewind key for set increments (e.g., one chapter) 40E, a fast-forward key for set increments (e.g., one chapter) 40F, and a pause key 40G, as graphic-bearing keys. Graphics are provided on the top surfaces of these keys as well.

When the play key 40A is operated, information that indicates “play” is sent to the DVD player 2. When the rewind key 40B is operated, information that indicates “rewind” is sent to the DVD player 2. When the fast-forward key 40C is operated, information that indicates “fast-forward” is sent to the DVD player 2. When the stop key 40D is operated, information that indicates “stop” is sent to the DVD player 2. When the rewind key 40E is operated or when the fast-forward key 40F is operated, information that indicates “rewind” or “fast-forward,” respectively, is output to the DVD player 2. When the pause key 40G is operated, information that indicates “pause” is output to the DVD player 2.

In addition, the operating device 1 is equipped with a tray open/close key 50 as a graphic-bearing key. When the tray open/close key 50 is operated, information for ordering a tray 5 (see FIG. 2) to open or information to order the tray 5 (see FIG. 2) to close is output to the DVD player 2.

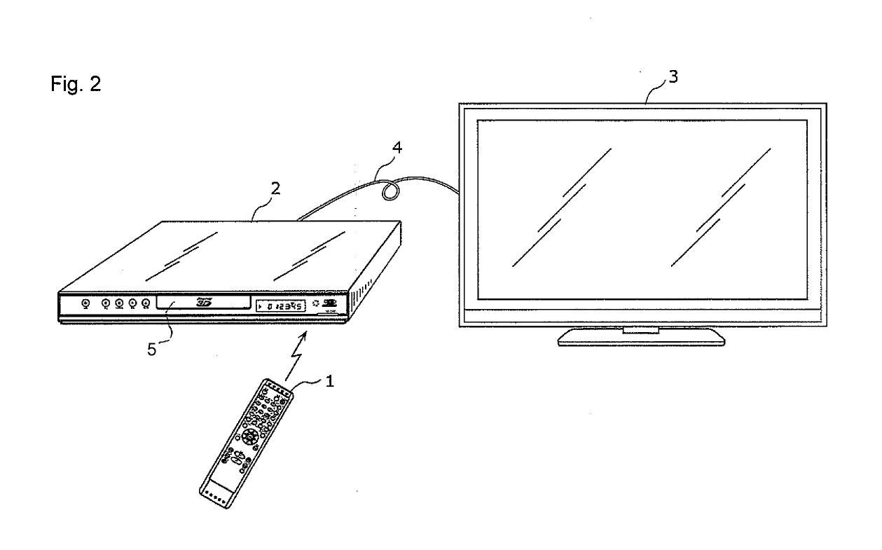

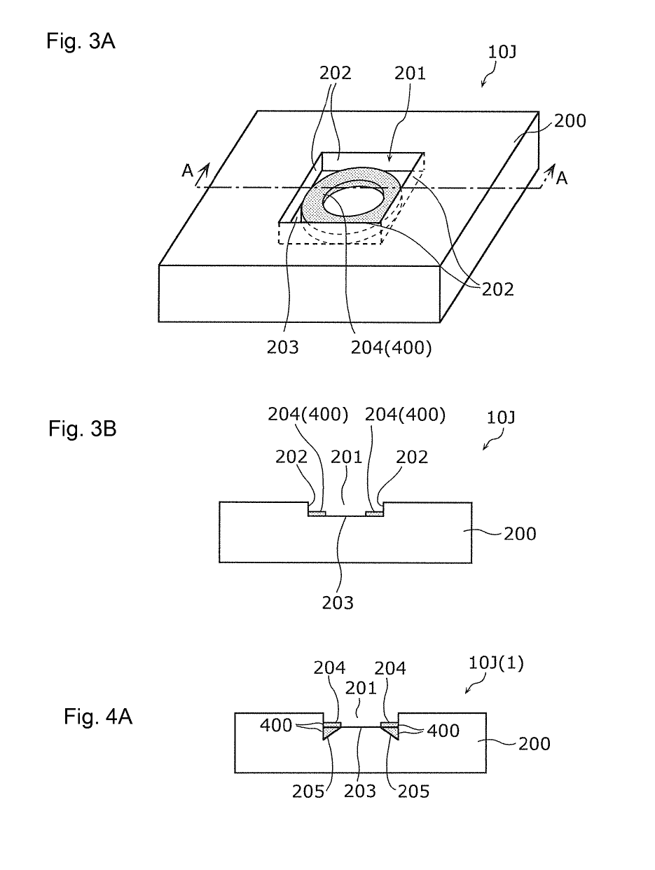

The configuration of the number key 10J will be described below as a graphic-bearing key using FIGS. 3A and 3B. FIG. 3A is a perspective view showing one example of the external appearance of the number key 10J. FIG. 3B is a sectional view along line A-A in FIG. 3A. Note that graphic-bearing keys other than the number key 10J preferably have the same configuration as the number key 10J, so the description thereof will be omitted.

The number key 10J, as with the other graphic-bearing keys, preferably has a rectangular or substantially rectangular parallelepiped-shaped main body 200 that is longer in the lateral direction.

A quadrangular recessed portion 201 is provided in the top surface of the main body 200. The recessed portion 201 includes four wall surfaces 202 and a bottom surface 203. A “0” is provided as a graphic 204 on the bottom surface 203. This graphic 204 is configured using paint 400 such that the four wall surfaces 202 touch this graphic 204. Note that all four wall surfaces 202 preferably are in contact with the graphic 204 in the present preferred embodiment, but the present invention is not limited to this example. It is sufficient if at least one of the wall surfaces 202 circumscribes the graphic 204.

With this configuration, the recessed portion 201 is provided in the top surface of the number key 10J, the recessed portion 201 includes the bottom surface 203 and wall surfaces 202, the graphic 204 is configured on the bottom surface 203 with paint 400, and the wall surfaces 202 circumscribe the graphic 204.

By doing so, the graphic 204 is in contact with the four wall surfaces 202 in the interior of the recessed portion 201.

For this reason, when the user presses the top surface of the number key 10J, it is difficult for the finger to reach the bottom portions of the wall surfaces 202 of the recessed portion 201, so chipping and peeling of the graphic 204 is significantly reduced or prevented. Furthermore, the graphic on the top surface of the number key 10J indicates the numeral “0,” so the user can ascertain that the numeral “0” is assigned to the number key 10J.

### Preferred Embodiment 2

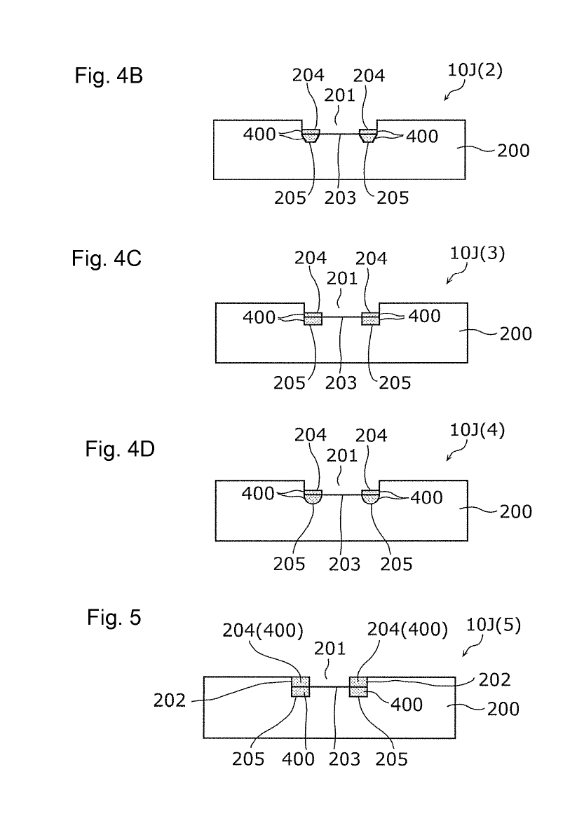

FIGS. 4A through 4D are sectional views showing examples of the configuration of an operating key according to Preferred Embodiment 2 of the present invention.

Each of the number keys 10J (1) through 10J (4) in FIGS. 4A through 4D differs from the number key 10J in Preferred Embodiment 1 in that there is a groove 205 directly underneath the graphic 204. Paint 400 that configures the graphic 204 is made to flow into the groove 205 and then placed in a dried state.

On the number key 10J (1) in FIG. 4A, the groove 205 is such that its cross section is triangular or substantially triangular with a vertex that exceeds 0° but is less than 90° facing downward. Note that, in FIG. 4A, the cross section of the groove 205 preferably has a triangular or substantially triangular shape with an acute angle facing downward, but the present invention is not limited to this example; it may also have a triangular or substantially triangular shape with an obtuse angle facing downward.

On the number key 10J (2) in FIG. 4B, the groove 205 preferably has a reverse trapezoid cross section. On the number key 10J (3) in FIG. 4C, the groove 205 preferably has a quadrangular cross section. On the number key 10J (4) in FIG. 4D, the groove 205 preferably has a cross section with the shape of a semicircle with the arc facing downward. Note that, in FIG. 4D, the cross section of the groove 205 preferably has a semicircular shape with the arc facing downward, but the present invention is not limited to this example; it may also be a downward facing curved shape, for example.

With this configuration, the groove 205 that corresponds to the shape of the graphic 204 is provided in the bottom surface 203, and paint 400 is made to flow into the groove 205, so even if the surface of the paint 400 that configures the graphic on the bottom surface 203 chips or peels, the legibility of the graphic on the top surface of the number key 10J is less susceptible to these effects.

When using the configuration of FIG. 4A, in particular, the groove 205 preferably has a cross section that is triangular or substantially triangular whose vertex faces downward, so the user's finger cannot easily reach the bottom of the groove 205. Because this reduces chipping and peeling of the paint 400 at the bottom of the groove 205, the legibility of the graphic on the top surface of the number key 10J (1) is less prone to these effects.

Moreover, when using the configuration of FIG. 4B, the cross section of the groove 205 preferably has a reverse trapezoid shape, so the user's finger cannot easily reach the lower portion of the groove 205. Because this reduces chipping and peeling of the paint 400 accumulated at the bottom of the groove 205, the legibility of the graphic on the top surface of the number key 10J (2) is less prone to these effects.

In addition, when using the configuration of FIG. 4C, because the cross-sectional shape of the groove 205 preferably is quadrangular or substantially quadrangular, it is easy to create the mold that is used when forming the groove 205.

Furthermore, when using the configuration of FIG. 4D, the groove 205 preferably has a cross section that is the shape of a semicircle whose arc faces downward, so the fingertip cannot easily reach the bottom portion of the groove 205. For this reason, chipping and peeling of the paint 400 accumulated at the bottom of the groove 205 is significantly reduced or prevented, so the legibility of the graphic on the top surface of the number key 10J (4) is less susceptible to these effects.

### Preferred Embodiment 3

FIG. 5 is a sectional view showing one example of the configuration of an operating key according to Preferred Embodiment 3 of the present invention. On this number key 10J (5), the height of the wall surfaces 202 from the bottom surface 203 is preferably the same or substantially the same as the height of the paint 400, applied in order to draw the graphic 204, from the bottom surface 203.

This makes the depression that outlines the graphic 204 shallow. As a result, any odd sensation felt when pressing the top surface of the number key 10J (5) is significantly reduced or prevented.

Moreover, the groove 205 preferably having a quadrangular or substantially quadrangular cross section is provided, and the paint 400 is made to flow into the groove 205 as well, so peeling of the graphic 204 is effectively reduced or prevented. Note that, in Preferred Embodiment 3, the configuration of the groove 205 preferably is not only the quadrangular cross section shown in FIG. 5 but may also be a triangular or substantially triangular cross section (see FIG. 4A), a reverse trapezoid-shaped cross section (see FIG. 4B), or a curve-shaped cross section (see FIG. 4D).

### Preferred Embodiment 4

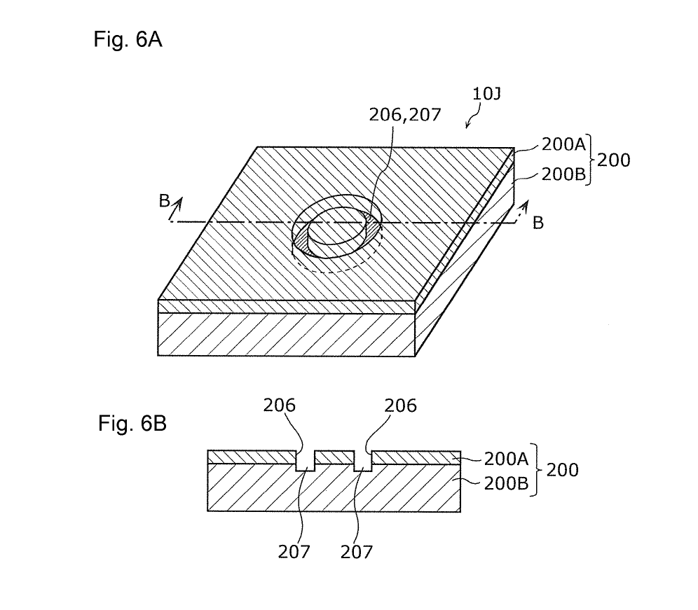

FIG. 6A is a perspective view showing one example of the external appearance of the operating key according to Preferred Embodiment 4 of the present invention. FIG. 6B is a sectional view along line B-B in FIG. 6A. Note that the configuration of the number key 10J is shown in FIGS. 6A and 6B. Graphic-bearing keys other than the number key 10J preferably have the same configuration as the number key 10J, so the description thereof will be omitted.

With this number key 10J, the main body 200 preferably is constituted by laminating a top-layer member 200A and a bottom-layer member 200B having a different color from the top-layer member 200A. Note that, in FIGS. 6A and 6B, the difference in color between the top-layer member 200A and the bottom-layer member 200B is expressed by the difference in the orientation of the hatching.

A hole 206 is formed in the shape of the graphic “0” in the top-layer member 200A, and a recessed portion 207 is provided in the bottom-layer member 200B directly under the hole 206. The graphic “0” is thus defined by the hole 206 and the recessed portion 207 that is directly beneath it. In addition, because the colors of the top-layer member 200A and the recessed portion 207 are different, a graphic “0” of a color different from the color of the top-layer member 200A can be seen on the top surface of the top-layer member 200A when the number key 10J is viewed from above or at an angle from above.

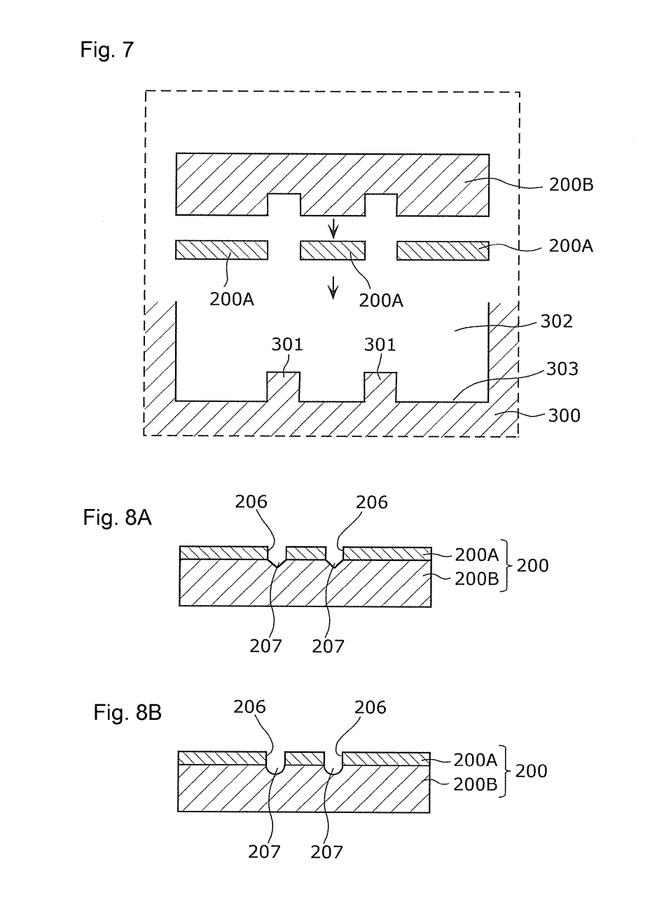

FIG. 7 is a diagram for illustrating a method for manufacturing the number key 10J according to Preferred Embodiment 4. The number key 10J is manufactured through the processes described below.

Specifically, a mold 300 is first prepared to have a space 302 that is elongated in the lateral direction and shortened in the vertical direction. A protrusion 301 that is taller than the height of the top-layer member 200A is provided on the bottom surface 303 of the mold 300 so as to define the shape of the graphic (here, “0”).

Melted resin that will serve as the top-layer member 200A is first poured into the space 302 of such a mold 300. Then, as soon as this resin hardens, melted resin that will serve as the bottom-layer member 200B is poured into the space 302. Once this resin hardens, each portion of the hardened resin is removed from the mold 300. Then, the number key 10J according to Preferred Embodiment 4 is completed.

With this configuration, the graphic is defined by the hole 206 in the top-layer member and the recessed portion 207 that is directly beneath it, so the shape of the graphic is even less prone to deterioration than the case in which the graphic is configured with the paint 400. Accordingly, it is possible to have the legibility of the graphic on the top surface of the number key 10J be less affected by deterioration.

In addition, the number key 10J in which the top-layer member 200A and the bottom-layer member 200B are laminated can be manufactured by using the mold 300 as described above, so the number key 10J is manufactured inexpensively and easily.

### Preferred Embodiment 5

FIGS. 8A and 8B are sectional views showing examples of the operating key according to Preferred Embodiment 5 of the present invention. Note that FIGS. 8A and 8B are sectional views along line B-B in FIG. 6A.

In FIG. 8A, the cross section of the recessed portion 207 preferably has a reverse triangle shape; in FIG. 8B, the cross section of the recessed portion 207 preferably has a semicircular shape with the arc facing downward, for example. Note that in FIG. 8B, the cross section of the recessed portion 207 preferably has a semicircular shape with the arc facing downward, but the present invention is not limited to this example; the cross section of the recessed portion 207 may also have a downward facing curved shape, for example.

Furthermore, the recessed portion 207 shown in FIG. 8A is preferably realized by providing the tip end of the protrusion 301A of the mold 300 with a triangular or substantially triangular shape. Moreover, the recessed portion 207 shown in FIG. 8B preferably is realized by providing the tip end of the protrusion 301A with an arc shape, for example.

If this configuration is used, with the number key 10J in FIG. 8A, the recessed portion 207 in the bottom-layer member 200B has a cross section that preferably is in the shape of a reverse triangle, so the fingertip cannot easily reach the bottom of the recessed portion 207. Therefore, the shape of the recessed portion 207 is less prone to deterioration, so it is possible to have the legibility of the graphic on the top surface of the number key 10J be less affected by deterioration.

In addition, with the number key 10J in FIG. 8B, the recessed portion 207 in the bottom-layer member 200B preferably has a cross section that is the shape of a semicircle whose arc faces downward, so the fingertip cannot easily reach the bottom of the recessed portion 207. Therefore, the shape of the recessed portion 207 is less prone to deterioration in the same way as described above, so it is possible to have the legibility of the graphic on the top surface of the number key 10J be less affected by deterioration.

### Preferred Embodiment 6

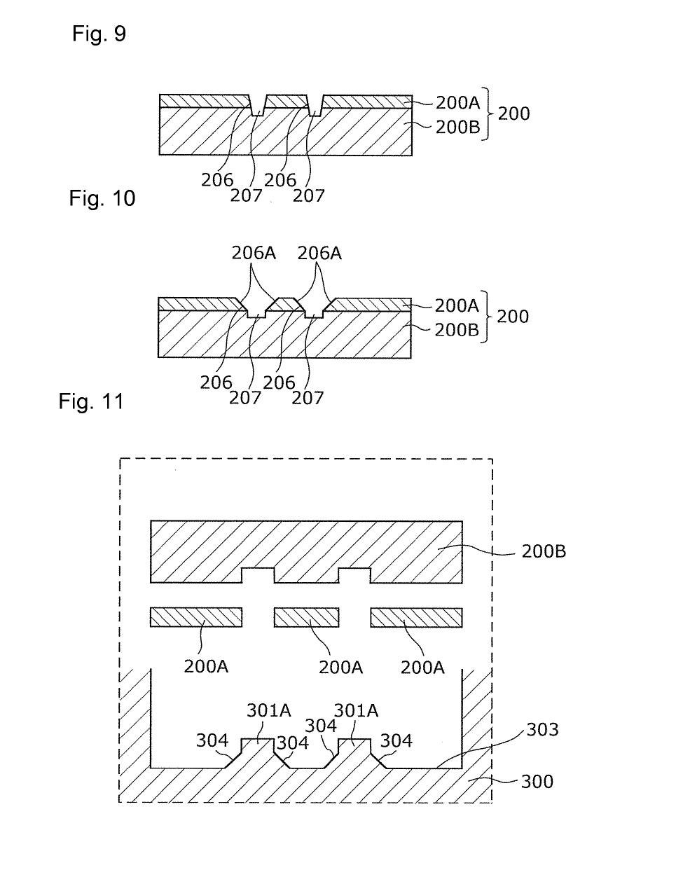

FIG. 9 is a sectional view showing one example of the configuration of the operating key according to Preferred Embodiment 6 of the present invention. Note that FIG. 9 is a sectional view along line B-B in FIG. 6A.

With this configuration, the hole 206 in the top-layer member 200A preferably has a shape that becomes narrower toward the bottom-layer member 200B, and the recessed portion in the bottom-layer member 200B preferably has a reverse trapezoid shape. Note that this configuration preferably is realized by forming the tip end of the protrusion 301A of the mold 300 such that its cross section preferably has a trapezoidal or substantially trapezoidal shape, for example.

With this configuration, the hole 206 of the top-layer member 200A preferably has a shape that becomes narrower toward the bottom-layer member 200B, and the recessed portion of the bottom-layer member 200B preferably has a reverse trapezoid shape. For this reason, it is difficult for a fingertip to reach deep into the hole 206 or deep into the recessed portion 207, so the hole 206 and the recessed portion 207 are not prone to deterioration.

As a result, the shape of the graphic expressed by the hole 206 and the recessed portion 207 is less prone to deterioration, so it is possible to have the legibility of the graphic on the top surface of the number key 10J be less affected by deterioration.

### Preferred Embodiment 7

FIG. 10 is a sectional view showing one example of the configuration of the operating key according to Preferred Embodiment 7 of the present invention. Note that FIG. 10 is a sectional view along line B-B in FIG. 6A.

With this configuration, the recessed portion 207 of the bottom-layer member 200B preferably has a quadrangular or substantially quadrangular cross section, but a tapered surface 206A is provided in the hole 206 of the top-layer member 200A. The tapered surface 206A is preferably provided with a large taper angle so as to improve the legibility of the graphic.

FIG. 11 is a diagram for illustrating a method for manufacturing the number key 10J according to Preferred Embodiment 7. The number key 10J according to Preferred Embodiment 7 is manufactured through the processes described below.

Specifically, a mold 300 is first prepared which has a space 302 that is elongated in the lateral direction and shortened in the vertical direction. A protrusion 301A that is taller than the height of the top-layer member 200A is formed on the bottom surface 303 of this mold 300 so as to form the shape of the character (here, “0”).

Furthermore, a tapered surface 304 is provided on the protrusion 301A.

Melted resin that will serve as the top-layer member 200A is first poured into the space 302 of such a mold 300. Then, as soon as this resin hardens, melted resin that will serve as the bottom-layer member 200B is poured into the space 302. Once this resin hardens, each portion of the hardened resin is removed from the mold 300. Then, the number key 10J according to Preferred Embodiment 7 is completed.

With this configuration, because the hole 206 of the top-layer member 200A is tapered, the graphic on the top surface of the number key 10J can be viewed not only from above but also at an angle from above, so the ease of use of the operating device 1 equipped with this operating key 10J is significantly increased.

The operating key and operating device according to the present invention were described above based on preferred embodiments, but the present invention is not limited to such preferred embodiments. The present invention also includes modes obtained by implementing various types of modifications to the preferred embodiments conceivable to a person skilled in the art within the scope that does not depart from the gist of the present invention, as well as other modes obtained by arbitrarily combining the constituent elements of the preferred embodiments.

Preferred embodiments of the present invention are preferably applied to devices equipped with operating keys such as remote controllers.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An operating key comprising:
a recessed portion provided in a top surface of the operating key and including a bottom surface and wall surfaces; and
a graphic configured with paint on the bottom surface; wherein
the graphic is circumscribed by at least a portion of the wall surfaces.

2. The operating key according to claim 1, wherein the bottom surface has a quadrangular or substantially quadrangular shape.

3. The operating key according to claim 1, wherein the graphic represents text.

4. The operating key according to claim 1, wherein a groove that corresponds to a shape of the graphic is provided in the bottom surface, and the groove is shaped such that the paint flows into the groove during formation of the graphic.

5. The operating key according to claim 4, wherein the groove has a cross section that is triangular or substantially triangular with a vertex facing downward.

6. The operating key according to claim 4, wherein the groove has a cross section with a reverse trapezoid shape.

7. The operating key according to claim 4, wherein the groove has a cross section that is quadrangular or substantially quadrangular.

8. The operating key according to claim 4, wherein the groove has a cross section with a downward-facing curved shape.

9. The operating key according to claim 1, wherein a height of the wall surfaces from the bottom surface is equal or substantially equal to a height of the paint from the bottom surface.

10. An operating key comprising:
a top-layer member;
a bottom-layer member that is different in color from the top-layer member and laminated with the top-layer member;
a hole having a shape of a graphic and provided in the top-layer member; and
a recessed portion provided in the bottom-layer member directly beneath the hole.

11. The operating key according to claim 10, wherein the recessed portion has a cross section with a reverse trapezoid shape.

12. The operating key according to claim 10, wherein the recessed portion has a cross section with a reverse triangle shape.

13. The operating key according to claim 10, wherein the recessed portion has a cross section with a downward-facing curved shape.

14. The operating key according to claim 10, wherein the hole of the top-layer member has a shape that becomes narrower toward the bottom-layer member.

15. The operating key according to claim 10, wherein the hole has a tapered shape.

16. An operating device comprising:
a plurality of the operating keys according to claim 1; wherein
each of the plurality of operating keys has a function assigned thereto; and
each of the plurality of operating keys is configured to be operated such that a signal that indicates the function assigned to the respective operating key is output.

17. The operating device according to claim 16, wherein a groove that corresponds to a shape of the graphic is provided in the bottom surface, and the groove is shaped such that the paint flows into the groove during formation of the graphic.

18. The operating device according to claim 17, wherein the groove has a cross section that is one of triangular or substantially triangular with a vertex facing downward, a reverse trapezoid shape, quadrangular or substantially quadrangular, a downward-facing curved shape.

19. The operating device according to claim 17, wherein a height of the wall surfaces from the bottom surface is equal or substantially equal to a height of the paint from the bottom surface.

20. An operating device comprising:
a plurality of the operating keys according to claim 10; wherein
each of the plurality of operating keys has a function assigned thereto; and
each of the plurality of operating keys is configured to be operated such that a signal that indicates the function assigned to the respective operating key is output.
